(19) United States
(12) Patent Application Publication
(10) Pub. No.: US 2016/0001597 A1
(43) Pub. Date: Jan. 7, 2016

(54) Wheel Bearing Apparatus

(71) Applicant: NTN Corporation, Osaka-shi (JP)

(72) Inventor: Kazuo KOMORI, Iwata-shi (JP)

(21) Appl. No.: 14/792,952

(22) Filed: Jul. 7, 2015

Related U.S. Application Data
(63) Continuation of application No. PCT/JP2014/050144, filed on Jan. 8, 2014.

(30) Foreign Application Priority Data
Jan. 9, 2013 (JP) 2013-001666

(51) Int. Cl. B60B 27/00; F16C 19/18

(52) U.S. Cl. CPC B60B 27/0084; B60B 27/0005; B60B 27/0073; B60B 27/0094; F16C 19/186

(57) ABSTRACT

A wheel bearing apparatus has an outer member, an inner member with an inner ring and double row rolling elements rollably contained between inner raceway surfaces of the inner member and outer raceway surfaces of the outer member. The inner ring is axially immovably secured on the wheel hub by a caulking portion. A thickness of a smaller end surface of the inner ring is larger than the height of a stepped portion of a wheel hub of the inner member. The axial position of the smaller end surface of the inner ring is set within an axial range between an axial position of the outermost-side point of the inner-side rolling elements of the double row rolling elements and an axial position of the groove bottom point of an inner raceway surface of the inner ring.

### CROSS-REFERENCE TO RELATED APPLICATIONS

This application is a continuation of International Application No. PCT/JP2014/050144, filed Jan. 8, 2014, which claims priority to Japanese Application No. 2013-001666, filed Jan. 9, 2013. The disclosures of the above applications are incorporating herein by reference.

### FIELD

The present disclosure generally relates to a wheel bearing apparatus that rotationally supports a wheel of a vehicle and, more particularly, to a wheel bearing apparatus with a self-retaining structure where an inner ring is secured on a wheel hub by swing caulking of the wheel hub. This is intended to suppress the hoop stress on the inner ring by the caulking process and to reduce bearing friction.

### BACKGROUND

There are two types of vehicle wheel bearing apparatus for automobiles, those used for driving wheels and those for driven wheels. In wheel bearing apparatus that rotationally supports wheels relative to a suspension apparatus of the automobile, it is desirable to reduce manufacturing cost, weight and size of the wheel bearing apparatus. A representative example of a prior art wheel bearing apparatus for a driven wheel is shown in FIG. 8.

The wheel bearing apparatus 50 is a third generation type used for a driven wheel. It includes an inner member 51, an outer member 60, and a plurality of balls 56, 56 contained between the inner member 51 and the outer member 60. The inner member 51 has a wheel hub 52 and an inner ring 53 press-fit onto the wheel hub 52.

The wheel hub 52 is integrally formed with a wheel mounting flange 54, to mount a wheel (not shown), on one end. Bolt apertures 55 are formed in the wheel mounting flange 54 to receive hub bolts (not shown) equidistantly along its periphery. The wheel hub 52 is integrally formed, on its outer circumference, with one inner raceway surface 52a. The wheel hub 52 has a cylindrical portion 52b axially extending from the inner raceway surface 52a through a stepped portion 61. The inner ring 53 is press-fit onto the cylindrical portion 52b. The inner ring 53 is formed, on its outer circumference, with the other inner raceway surface 53a.

A caulking portion 52c is formed by plastically deforming the end of the cylindrical portion 52b radially outward. A smaller end surface 53c of the inner ring 53 abuts against the stepped portion 61. That is, the inner ring 53 is secured relative to the wheel hub 52 by sandwiching the inner ring 53 between the caulking portion 52c and the stepped portion 61 of the wheel hub 52. The caulking portion 52c is plastically deformed while being closely contacted against the larger end surface 53b of the inner ring 53. Thus, it is possible to surely keep a desired axial force pressing the inner ring 53 against the stepped portion 61 of the wheel hub 52.

The outer member 60 has, on its outer circumference, an integrally formed body mounting flange (not shown). The outer member 60 includes double row outer raceway surfaces 60a, 60a on its inner circumference. The double row balls 56, 56, are rollably held by cages 57, 57. The double row balls 56, 56 are contained in a space formed between the outer raceway surfaces 60a, 60a and the inner raceway surfaces 52a, 53a. Seals 58, 59 are mounted on the ends of the outer member 60. The seals 58, 59 prevent leakage of lubricant grease sealed within the bearing as well as entry of rain water or dust into the bearing from the outside.

The wheel hub 52 is made of medium-high carbon steel such as S53C including carbon of 0.40-0.80% by weight. It is hardened by high frequency induction hardening to have a surface hardness of 58-64 HRC over a region including the inner raceway surface 52a, a seal land contacted by seal 58, and the cylindrical portion 52b. The caulking portion 52c is not hardened. The caulking portion 52c is kept to have a surface hardness less than 25 HRC after forging. The inner ring 53 is formed of high carbon chrome steel such as SUJ2. It is dip hardened to its core to have a hardness of 58-64 HRC.

Similarly to the wheel hub 52, the outer member 60 is formed of medium-high carbon steel such as S53C including carbon of 0.40-0.80% by weight. The wheel hub 52 is formed with double row outer raceway surfaces 60a, 60a hardened by high frequency induction hardening to have a surface hardness of 58-64 HRC.

As shown in an enlarged view of FIG. 9, an annular recessed portion 62 is formed on the inner circumference of the inner ring 53. The recessed portion 62 is formed in substantially the entire range of the axial width of the inner raceway surface 53a of the inner ring 53. The recessed portion 62 has a circular-arc shaped longitudinal section with its largest depth at its axially center position.

The provision of the recessed portion 62 on the inner circumference of the inner ring 53 makes it possible to relieve the radially expanding force applied to the inner raceway surface 53a on the outer circumference of the inner ring 53 caused during the press-fitting process of the inner ring 53 onto the wheel hub 52. Thus, this suppresses an increase of the hoop stress caused on the inner raceway surface 53a of the inner ring 53. In addition, the recessed portion 62 can also relieve an increase of hoop stress caused on the inner raceway surface 53a of the inner ring 53 by caulking the caulking portion 52c. Accordingly, it is possible to suppress an increase of the hoop stress caused on the inner raceway surface 53a during the press-fitting process of the wheel hub 52 onto the cylindrical portion 52b without an increase of the radial dimension and width dimension of the inner ring 53, see, JP 2008-19899 A.

The prior art wheel bearing apparatus 50 can suppress the hoop stress caused on the inner raceway surface 53a of the inner ring 53 by press-fitting the inner ring 53 onto the wheel hub 52 and caulking the caulking portion 52c. Wheel bearing apparatus of caulking type have recently been required to improve durability of the inner ring 53 by suppressing the hoop stress, to reduce friction of the bearing, and, in addition, reduce weight and size in order to improve fuel consumption.

It has been considered effective to reduce friction of the bearing by reducing the bearing clearance after caulking and, more particularly, to reduce the negative clearance range. It is important to examine the bearing specifications where both the suppression of the hoop stress and the reduction of friction are considered.

A relationship between the bearing friction and the bearing clearance after caulking is known. It is schematically shown in FIG. 10. Thus, a reduction of friction can be realized by suppressing variation of the negative clearance where the clearance after caulking is hard since a hatched portion can be suppressed.

### SUMMARY

It is therefore an object of the present disclosure to provide a wheel bearing apparatus that can suppress the hoop stress of the inner ring caused by the caulking process and reduce the bearing friction while suppressing the clearance range after caulking.

To achieve the above mentioned objects, according to the present disclosure, a wheel bearing apparatus comprises an outer member, an inner member and rolling members between the two. The outer member is integrally formed with a body mounting flange on its outer circumference. The outer member inner circumference includes double row outer raceway surfaces. The inner member includes a wheel hub and an inner ring. The wheel hub is integrally formed on its one end with a wheel mounting flange. The wheel hub outer circumference includes one inner raceway surface opposing one of the outer raceway surfaces. A cylindrical portion axially extends from the inner raceway surface through a stepped portion. The inner ring is formed with the other inner raceway surface on its outer circumference. The other inner raceway surface opposes the other of the double row outer raceway surfaces. Double row rolling elements are rollably contained between the inner raceway surfaces of the inner member and the outer raceway surfaces of the outer member. The inner ring is axially immovably secured on the wheel hub by a caulking portion. The caulked portion is formed by plastically deforming, radially outward, an end of the cylindrical portion of the wheel hub. The thickness of a smaller end surface of the inner ring is larger than the height of the stepped portion of the wheel hub. The axial position of the smaller end surface of the inner ring is set within an axial range between the axial position of the outermost-side point of the inner-side rolling elements of the double row rolling elements and the axial position of the groove bottom point of the inner raceway surface of the inner ring.

The wheel bearing apparatus of the present disclosure is of a “third generation” type. The inner ring is axially immovably secured on the wheel hub by a caulking portion. The caulking portion is formed by plastically deforming, radially outward, an end of the cylindrical portion of the wheel hub. The thickness of a smaller end surface of the inner ring is larger than the height of the stepped portion of the wheel hub. The axial position of the smaller end surface of the inner ring is set within an axial range between the axial position of the outermost-side point of the inner-side rolling elements of the double row rolling elements and the axial position of the groove bottom point of the inner raceway surface of the inner ring. Thus, it is possible to provide a wheel bearing apparatus that can reduce bearing friction by reducing the sensitivity of the elastic deformation of the inner ring during the caulking process and by suppressing variation of the negative clearance after caulking.

A value is obtained by dividing a dimensionless value of the area of the smaller end surface of the inner ring by a dimensionless value of the inner diameter of the inner ring. The value is set to 11 or more. This makes it possible to suppress both the hoop stress caused by the caulking process and the variation of the bearing clearance after caulking. Thus, this further reduces the bearing friction.

A recessed portion is formed on the inner-side end of the wheel hub. The depth of the recessed portion extends to the axial position of the stepped portion of the wheel hub. The cylindrical portion has a circular cross-section. This makes it possible to reduce weight of the wheel hub and the hoop stress caused on the inner ring while suppressing expansion of the inner ring during the caulking process.

A spacer, with a rectangular longitudinal section, is disposed on the cylindrical portion of the wheel hub. Thus, the inner ring is secured on the wheel hub with the inner ring. The spacer is sandwiched between the caulking portion and the stepped portion of the wheel hub. This makes it possible to improve the durability of the inner ring while reducing the deformation and therefore hoop stress of the inner ring and maintain the bearing preload at a proper value.

The pitch circle diameter of the inner-side rolling elements of the double row rolling elements is larger than the pitch circle diameter of the outer-side rolling elements of the double row rolling elements. The size of each double row rolling element is the same. The number of the inner-side rolling elements is larger than that of the outer-side rolling elements. This makes it possible to increase the bearing rigidity of the inner-side portion compared with the outer-side portion. Thus, this improves the bearing life. Also, it is possible to prevent a reduction of the roundness of the inner raceway surface of the inner ring while suppressing deformation of the inner ring during the caulking process.

The wheel bearing apparatus of the present disclosure comprises an outer member, an inner member and rolling elements. The outer member is integrally formed with a body mounting flange on its outer circumference. The outer member inner circumference includes double row outer raceway surfaces. The inner member includes a wheel hub and an inner ring. The wheel hub is integrally formed on its one end with a wheel mounting flange. The wheel hub outer circumference includes one inner raceway surface opposing one of the outer raceway surfaces. A cylindrical portion axially extends from the inner raceway surface through a stepped portion. The inner ring is formed with the other inner raceway surface on its outer circumference. The other inner raceway surface opposes the other of the double row outer raceway surfaces. Double row rolling elements are rollably contained between the inner raceway surfaces of the inner member and the outer raceway surfaces of the outer member. The inner ring is axially immovably secured on the wheel hub by a caulking portion. The caulked portion is formed by plastically deforming, radially outward, an end of the cylindrical portion of the wheel hub. The thickness of a smaller end surface of the inner ring is larger than the height of the stepped portion of the wheel hub. The axial position of the smaller end surface of the inner ring is set within an axial range between the axial position of the outermost-side point of the inner-side rolling elements of the double row rolling elements and the axial position of the groove bottom point of the inner raceway surface of the inner ring. Thus, it is possible to provide a wheel bearing apparatus that can reduce bearing friction by reducing the sensitivity of the elastic deformation of the inner ring during the caulking process and by suppressing variation of the negative clearance after caulking.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal-section view of a first embodiment of a wheel bearing apparatus of the present disclosure.

FIG. 2 is a partially enlarged view of FIG. 1.

FIG. 3 is a graph showing a relationship between a ratio of an area of a smaller end surface of the inner ring and a push-in amount limitation of the inner ring.

FIG. 4 is a schematically view showing the inner ring.

FIG. 5 is a graph showing a relationship between the bearing friction and the bearing clearance after caulking.

FIG. 6 is a longitudinal-section view of a second embodiment of a wheel bearing apparatus of the present disclosure.

FIG. 7 is a longitudinal-section view of a third embodiment of a wheel bearing apparatus of the present disclosure.

FIG. 8 is a longitudinal-section view of a prior art wheel bearing apparatus.

FIG. 9 is a partially enlarged view of FIG. 8.

FIG. 10 is a graph showing a relationship between the bearing friction and the bearing clearance after caulking.

### DETAILED DESCRIPTION

A wheel bearing apparatus comprises an outer member, an inner member and rolling elements. The outer member is integrally formed with a body mounting flange on its outer circumference. The outer member inner circumference includes double row outer raceway surfaces. The inner member includes a wheel hub and an inner ring. The wheel hub is integrally formed on its one end with a wheel mounting flange. The wheel hub outer circumference includes one inner raceway surface opposing one of the outer raceway surfaces. A cylindrical portion axially extends from the inner raceway surface through a stepped portion. The inner ring is formed with the other inner raceway surface on its outer circumference. The other inner raceway surface opposes the other of the double row outer raceway surfaces. Double row rolling elements are rollably contained between the inner raceway surfaces of the inner member and the outer raceway surfaces of the outer member. Seals are mounted in annular openings formed between the outer member and the inner member. The inner ring is axially immovably secured on the wheel hub under a predetermined bearing preloaded state by a caulking portion. The caulking portion is formed by plastically deforming, radially outward, an end of the cylindrical portion of the wheel hub. A thickness of a smaller end surface of the inner ring is larger than a height of the stepped portion of the wheel hub. A value obtained by dividing a dimensionless value of the area of the smaller end surface of the inner ring by a dimensionless value of the inner diameter of the inner ring is set to 11 or more. The axial position of the smaller end surface of the inner ring is set within an axial range between the axial position of the outermost-side point of the inner-side rolling elements of the double row rolling elements and the axial position of the groove bottom point of the inner raceway surface of the inner ring.

Preferable embodiments of the present disclosure will be described with reference to the accompanied drawings.

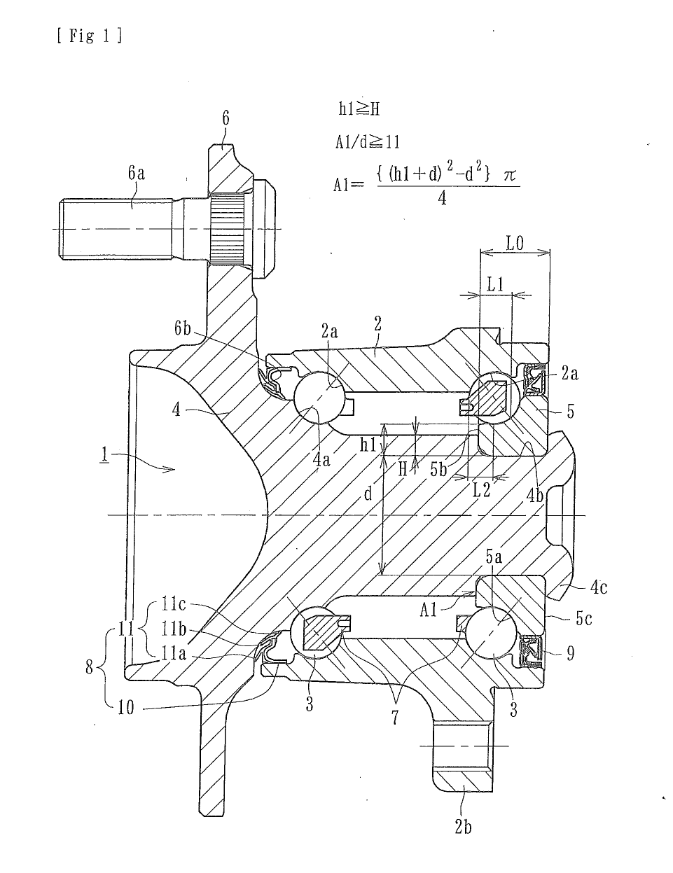

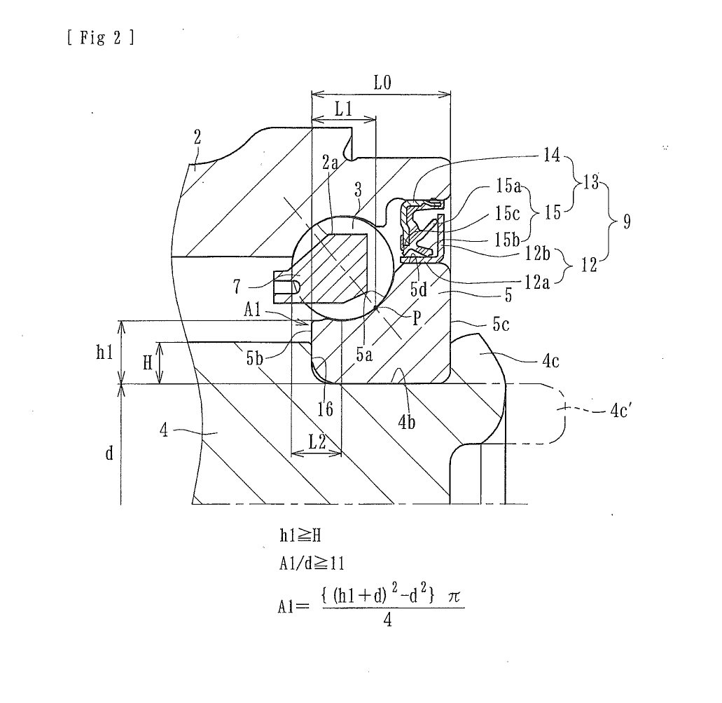

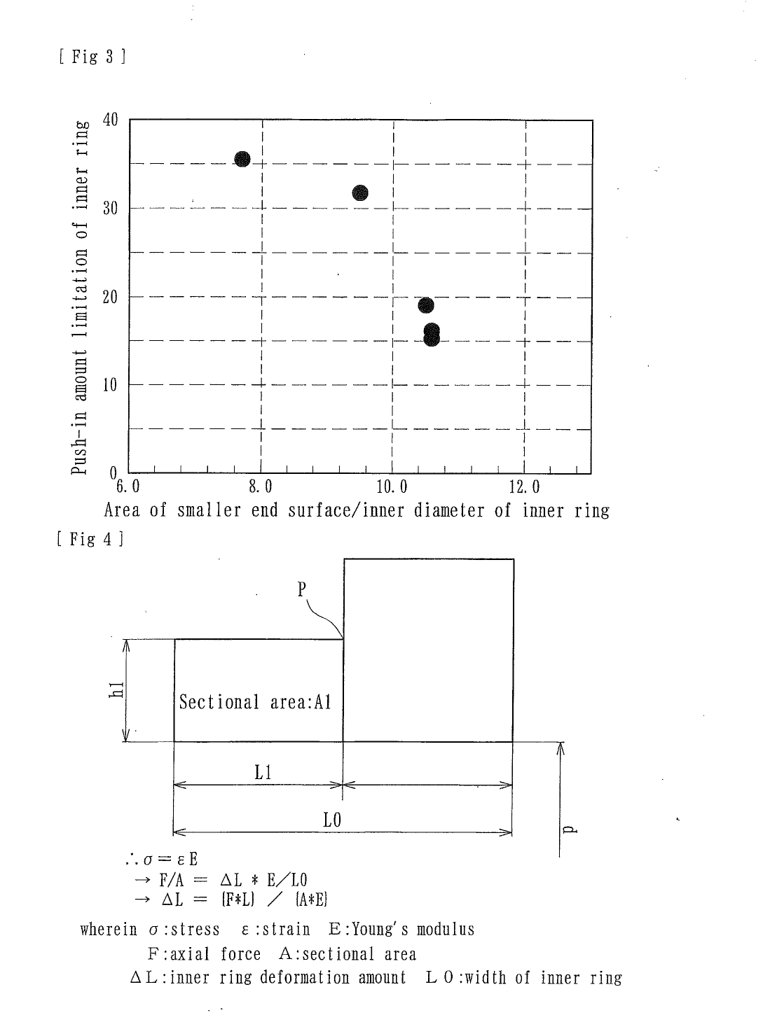

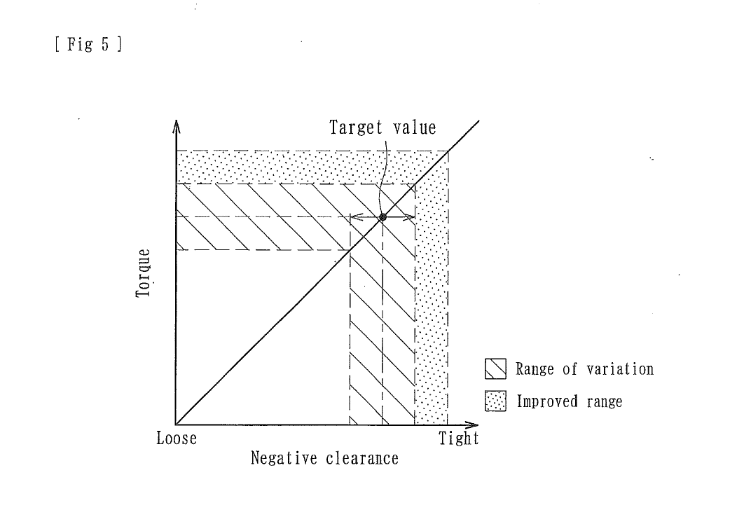

FIG. 1 is a longitudinal-section view of a first embodiment of a wheel bearing apparatus of the present disclosure. FIG. 2 is a partially enlarged view of FIG. 1. FIG. 3 is a graph showing a relationship between a ratio of an abutting area of a smaller end surface/an inner diameter of the inner ring and a push-in amount limitation of the inner ring. FIG. 4 is a view schematically showing the inner ring. FIG. 5 is a graph showing a relationship between the bearing friction and the bearing clearance after caulking. In the description below, an outer-side of the wheel bearing apparatus when it is mounted on a vehicle is referred to as “outer-side” (a left side in a drawing). An inner-side of the wheel bearing apparatus when it is mounted on a vehicle is referred to as “inner side” (a right side in a drawing).

The wheel bearing apparatus of the present disclosure is a so-called “third generation” type for a driven wheel. It comprises an inner member 1, an outer member 2, and double row rolling elements (balls) 3, 3 rollably contained between the inner member 1 and the outer member 2. The inner member 1 includes a wheel hub 4 and an inner ring 5 press-fit onto the wheel hub 4, via a predetermined interference.

The wheel hub 4 is integrally formed, on its outer-side end, with a wheel mount flange 6 to mount a wheel (not shown). Hub bolts 6a are secured on the wheel mounting flange 6 at circumferentially equidistant positions. In addition, the wheel hub 4 is formed, on its outer circumference, with one (outer-side) inner raceway surface 4a of a circular-arc longitudinal-section. A cylindrical portion 4b axially extends from the inner raceway surface 4a.

The inner ring 5 is formed, on its outer circumference, with the other (inner-side) inner raceway surface 5a of a circular-arc longitudinal-section. The inner ring 5 is press-fit onto the cylindrical portion 4b via a predetermined interference. This forms a double row angular contact ball bearing of a back-to-back duplex type. The inner ring 5 is axially immovably secured on the wheel hub 4 by a caulking portion 4c. The caulked portion 4c is formed by plastically deforming the end of the cylindrical portion 4b radially outward. This makes it possible to reduce the weight and size of the wheel bearing apparatus. The inner ring 5 and the balls 3, 3 are formed of high carbon chrome steel such as SUJ2. They are dip hardened to their cores to have a hardness of 58-64 HRC.

The wheel hub 4 is formed of medium-high carbon steel such as S53C including carbon of 0.40-0.80% by weight. It is hardened by high frequency induction hardening to have a surface hardness of 58-64 HRC. The surface hardness is over a region from an inner-side base 6b of the wheel mounting flange 6, forming a seal-land portion for a seal 8, to the cylindrical portion 4b. The caulking portion 4c is not hardened and kept with its original hardness after forging. This makes it possible to apply sufficient mechanical strength against the rotary bending of the wheel mounting flange 6, improve the anti-fretting property and perform the caulking process of the caulking portion 4c without causing generation of any micro cracks.

The outer member 2 is formed, on its outer circumference, with a body mounting flange 2b. The body mounting flange 2b is adapted to be mounted on a knuckle (not shown). The outer member inner circumference includes double row outer raceway surfaces 2a, 2a that correspond to the inner raceway surfaces 4a, 5a of the inner member 1. The balls 3, 3 are rollably contained between these outer and inner raceway surfaces 2a, 2a and 4a, 5a and are held by cages 7, 7.

Similarly to the wheel hub 4, the outer member 2 is formed of medium-high carbon steel such as S53C including carbon of 0.40-0.80% by weight. At least the double row outer raceway surfaces 2a, 2a are hardened by high frequency induction hardening to have a surface hardness of 58-64 HRC. Seals 8, 9 are mounted in annular openings formed between ends of the outer member 2 and the inner member 1. The seals 8, 9 prevent leakage of lubricating grease sealed within the bearing and entry of rain water or dust from the outside into the bearing.

The outer-side seal 9 is formed as an integrated seal. It includes a metal core 10 press-fit into the outer-side end of the outer member 2, via a predetermined interface. A sealing member 11 is adhered to the metal core 10 by vulcanizing adhesion. The metal core 10 is press-formed from austenitic stainless steel sheet (JIS SUS 304 etc.) or cold rolled steel sheet (JIS SPCC etc.) to have a substantially L-shaped longitudinal section.

On the other hand, the sealing member 11 is formed from synthetic rubber such as NBR (acrylonitrile-butadiene rubber). It includes a side lip 11a and a dust lip 11b inclined radially outward and in sliding-contact with the inner-side base 6b, with a circular arc section, of the wheel mounting flange 6 via a predetermined axial interference. A grease lip 11c slidingly-contacts the base 6b via a predetermined interference.

There are materials forming the sealing member 11 other than NBR, for example, HNBR (hydrogenation acrylonitrile-butadiene rubber), EPDM (ethylene propylene rubber) etc. superior in heat, and ACM (poly-acrylic rubber), FKM (fluororubber), silicone rubber etc. superior in chemical resistance.

On the other hand, the inner-side seal 9 is formed as a so-called pack seal. It includes a slinger 12 and a sealing plate 13 oppositely arranged as shown in FIG. 2. The slinger 12 is formed from a steel plate such as ferritic stainless steel sheet (JIS SUS 430 etc.) or preserved cold rolled steel sheet (JIS SPCC etc.). The slinger 12 is press worked to have a substantially L-shaped section. A cylindrical portion 12a is to be press-fit onto the outer circumference 5d of the inner ring 5. A standing portion 12b extends radially outward from the cylindrical portion 12a.

The sealing plate 13 includes a metal core 14 to be fit into the end of the outer member 2. A sealing member 15 is integrally adhered to the metal core 14 by vulcanizing adhesion. The metal core 14 is press-formed from austenitic stainless steel sheet or preserved cold rolled steel sheet to have a substantially L-shaped longitudinal section.

The sealing member 15 is formed from synthetic rubber such as NBR etc. The seaing member 15 includes a side lip 15a, extending radially outward in inclined manner, a bifurcated dust lip 15b and a grease lip 15c, positioned radially inward from the side lip 15a. The side lip 15a slidingly-contacts with an outer-side surface of the standing portion 12b of the slinger 12, via a predetermined axial interface. The dust lip 15b and the grease lip 15c slidingly-contact the cylindrical portion 12a, via a predetermined radial interface. The sealing member 15 may be formed by any material other than NBR, for example by HNBR (hydrogenation acrylonitrile-butadiene rubber), EPDM (ethylene propylene rubber) etc. superior in heat, and ACM (poly-acrylic rubber), FKM (fluororubber), silicone rubber etc. superior in chemical resistance.

Although the wheel bearing apparatus is shown with a double row angular contact ball bearing using balls as the rolling elements 3, the present disclosure is not limited to such a bearing and may utilize a double row tapered roller bearing using tapered rollers as rolling elements.

In the wheel bearing apparatus of this caulking type, it has been found that the bearing clearance after caulking is reduced as compared with the bearing clearance before caulking due to elastic deformation of the inner ring 5 caused by the caulking. However, with respect to the variation of clearance (i.e. range of variation of clearance), it is usually increased. For example, when the variation of clearance before caulking is 20 μm, the variation of clearance after caulking would not be wholly shifted by caulking and would be increased to 40 μm. It is supposed that this will be increased due to the variation of the elastic deformation of the inner ring 5.

The applicant has noticed that reduction of the bearing friction could be achieved by suppressing the bearing clearance after caulking while reducing the variation of the elastic deformation of the inner ring. Thus, this reduces the sensitivity of elastic deformation of the inner ring.

The inner ring 5 is axially immovably secured on the cylindrical portion 4b of the wheel hub 4. It is secured under a state where a predetermined bearing preload is applied first by press-fitting the inner ring 5 onto the cylindrical portion 5b until the smaller end surface 5b abuts against the shoulder 16 of the wheel hub 4. The end of the hub 4c is then plastically deformed radially outward using a caulking jig (caulking punch). The caulked portion contacts the larger end surface 5c to axially and elastically deform (compress) the inner ring 5 and to form the caulked portion 4c.

The variation (range) of bearing clearance after caulking is a total of a variation of initial clearance before caulking and a variation of clearance reduction due to caulking. The applicant has noticed that a portion of the inner ring 5 from a contact point P (hereinafter referred to as “touch position P”) between the inner raceway surface 5a and the balls 3 to the outer side portion of the inner ring 5 will give so much influence to the variation of clearance reduction due to caulking. Thus, the thickness of the smaller end surface 5b of the inner ring 5 is set large.

More particularly, the thickness hi of the smaller end surface 5b of the inner ring 5 is larger than the height H of the stepped portion 16 of the wheel hub 4 (h1≧H). The distance L1 from the touch position P of the inner ring 5 to the smaller end surface 5b is set small. A ratio of the area A1 of the smaller end surface 5b of the inner ring 5 to the inner diameter d of the inner ring 5 is set. A value is obtained by dividing a dimensionless value of the area of the smaller end surface 5b of the inner ring 5 by a dimensionless value of the inner diameter d of the inner ring 5 and it is set to 11 or more (A1/d≧11). In addition, the axial position of the smaller end surface 5b of the inner ring 5 is set within an axial range L2. L2 is defined between the axial position of the outermost-side point of the inner-side rolling elements 3 of the double row rolling elements 3, 3 and the axial position of the groove bottom point of the inner raceway surface 5a of the inner ring 5. This makes it possible to reduce the bearing friction by reducing the sensitivity of the elastic deformation of the inner ring 5 during the caulking process and by suppressing variation of the negative clearance after caulking.

As can be seen from the relationship between a ratio of the area A1 of a smaller end surface 5b of the inner ring 5 and inner ring diameter (A1/d) and a push-in amount limitation of the inner ring 5, shown in FIG. 3, and verified by the applicant, the sensitivity of the elastic deformation of the inner ring 5 tends to be reduced if a ratio of a dimensionless value of the area A1 of the smaller end surface 5b of the inner ring 5 to a dimensionless value of the inner diameter d of the inner ring 5 is set to 11 or more (A1/d≧11). That is, when considering a schematically shown inner ring of FIG. 4, an outer-side portion L1 of the inner ring from the touch position P I gives large influence to change of the bearing clearance when the inner ring 5 is axially compressed by caulking.

The deformation amount of the inner ring 5 when a certain load is applied to the inner ring 5 can be obtained from a formula below:

Since σ=εE, it can be expressed as F/ΔL×E/L0, and thus ΔL=(F×L0)/(A×E)

wherein σ: stress, ε: strain, E; Young's modulus, F: axial force, A: sectional area of inner ring, AL: deformation amount of inner ring, and L0: width of inner ring.

When applying this to FIG. 4, the deformation of the inner ring 5 relating to the clearance reduction can be expressed as (FL1)/(A1×E), wherein A1={(h1+d)²−d²}n/4

Considering that the load (axial force F) is constant and the Young's modulus E is the same because of using the same material, it can be understood from the formula above that the deformation of the inner ring 5 will become small when L1 is small and A1 is large (the thickness of the smaller end 5b is large). That is, the sensitivity of elastic deformation due to caulking can be suppressed low.

The longitudinal section of the inner ring 5 is substantially square. Thus, the smaller the width of the smaller end 5b of the inner ring 5, the lower the sensitivity of elastic deformation of the inner ring. However, if setting the position of the smaller end 5b of the inner ring 5 at an inner position other than an axial position corresponding to the groove bottom position of the inner raceway surface 5a of the inner ring 5, the balls 3 would roll on the end of the inner raceway surface 5a and cause generation of noise or fatigue ablation. On the other hand, if setting the position of the smaller end 5b of the inner ring within an axial range L2 between the axial position of the outermost-side point of the inner-side rolling elements 3 of the double row rolling elements 3, 3 and the axial position of the groove bottom point of the inner raceway surface 5a of the inner ring 5, it is possible to reduce the sensitivity of the elastic deformation of the inner ring 5 and to reduce the manufacturing cost while reducing the weight and size as well as grinding process range of the inner ring 5 and the wheel hub 4.

In other words, it is possible to totally reduce the bearing friction by totally reducing the range of variation (shown by hatchings) with assigning the reduced part of variation range to reduction of variation of tight clearance side after caulking.

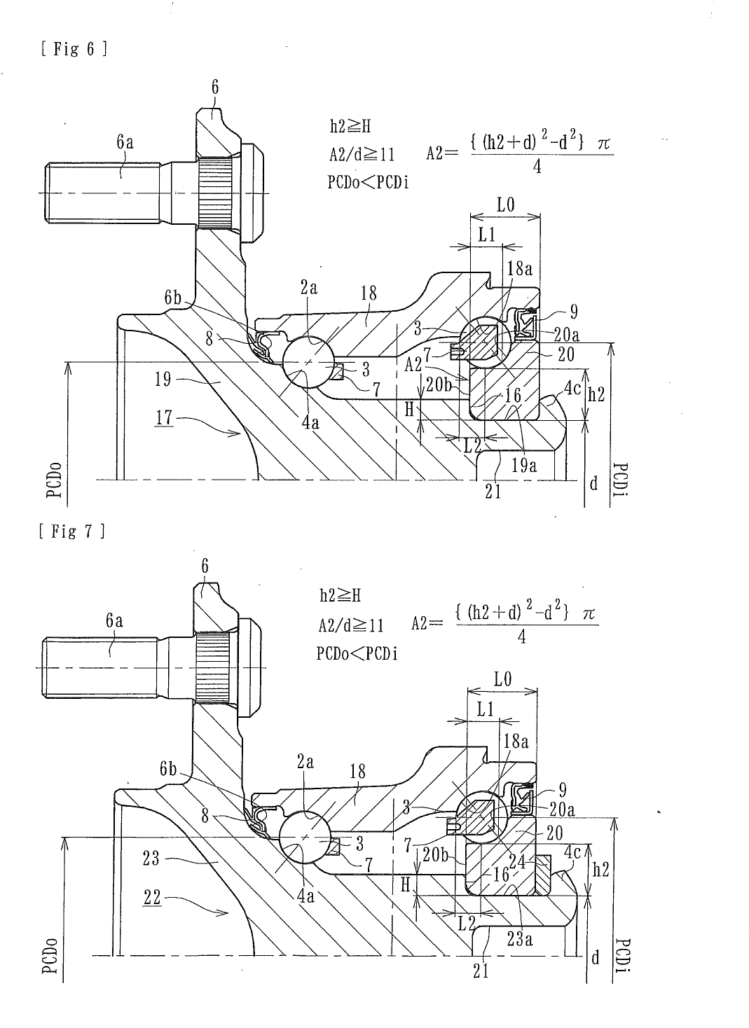

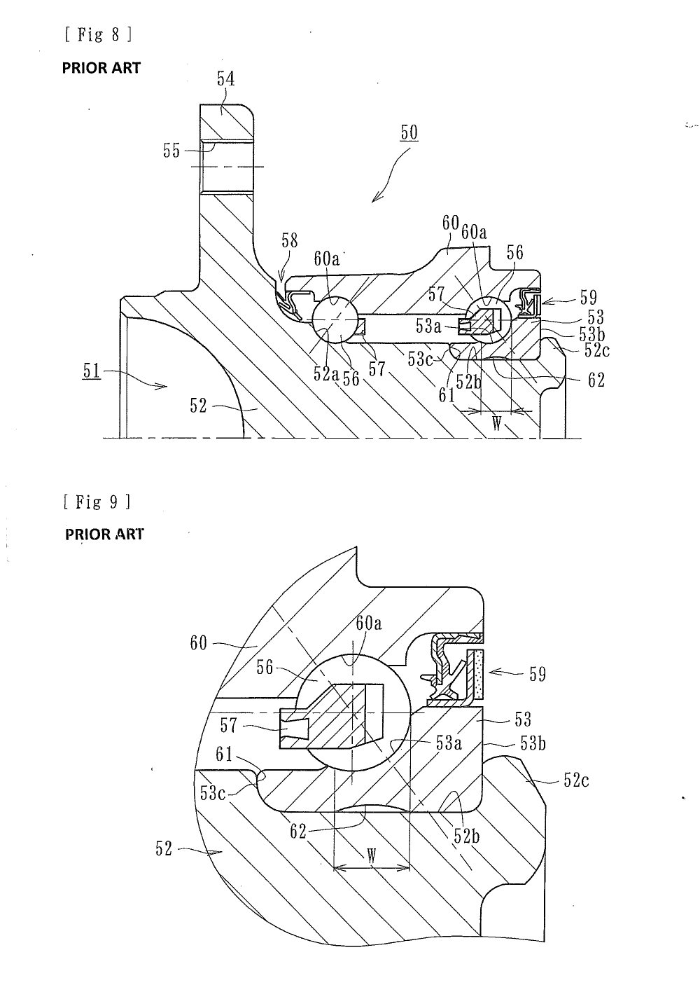

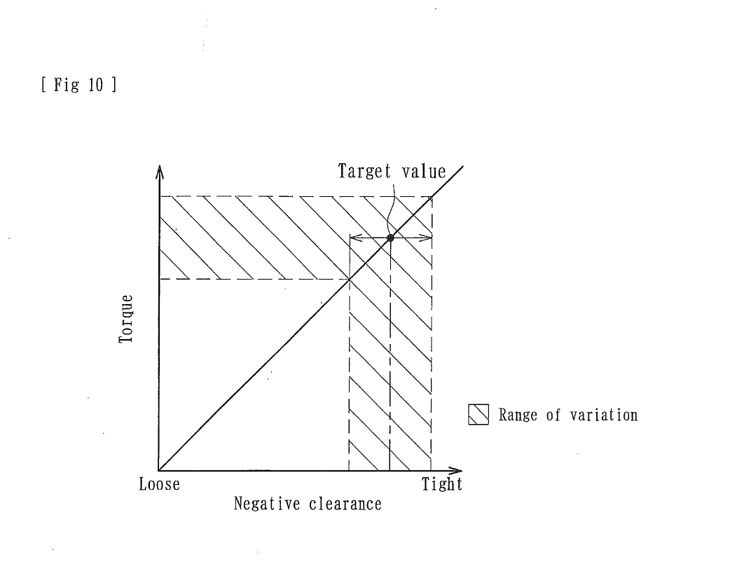

FIG. 6 is a longitudinal-sectional view of a second embodiment of a wheel bearing apparatus of the present disclosure. This embodiment is different from the first embodiment (FIGS. 1 and 2) basically in difference of pitch circle diameters of the inner-side and outer-side rolling elements (balls). Accordingly, the same reference numerals are used to designate the same structural elements of the previous embodiment and the detailed description will be omitted.

This wheel bearing apparatus of the second embodiment is also a so-called “third generation” type for a driven wheel. It comprises an inner member 17, an outer member 18, and double row rolling elements (balls) 3, 3 rollably contained between the inner member 17 and the outer member 18. The inner member 17 includes a wheel hub 19 and an inner ring 20 press-fit onto the wheel hub 19 via a predetermined interference.

The wheel hub 19 is integrally formed, on its outer-side end, with the wheel mount flange 6 to mount a wheel (not shown). The wheel hub 19 includes one (outer-side) inner raceway surface 4a, of a circular-arc longitudinal-section, on its outer circumference. A cylindrical portion 19a axially extends from the inner raceway surface 4a. The inner ring 20 is formed, on its outer circumference, with the other (inner-side) inner raceway surface 20a, of a circular-arc longitudinal-section. The inner ring 20 is press-fit onto the cylindrical portion 19a of the wheel hub 19 via a predetermined interference. The inner ring 20 is axially immovably secured on the wheel hub 19 by a caulking portion 4c. The caulking portion 4b is formed by plastically deforming the end of the cylindrical portion 19a radially outward.

The wheel hub 19 is formed of medium-high carbon steel such as S53C including carbon of 0.40-0.80% by weight. It is hardened by high frequency induction hardening to have a surface hardness of 58-64 HRC over a region from an inner-side base 6b of the wheel mounting flange 6 to the cylindrical portion 19a. The inner ring 20 is formed from high carbon chrome steel such as SUJ2 and dip hardened to its core to have a hardness of 58-64 HRC.

The outer member 18 is formed, on its outer circumference, with a body mounting flange (not shown). The outer member includes inner circumference double row outer raceway surfaces 2a, 18a. The outer member 18 is formed of medium-high carbon steel such as S53C including carbon of 0.40-0.80% by weight. At least the double row outer raceway surfaces 2a, 18a are hardened by high frequency induction hardening to have a surface hardness of 58-64 HRC.

In this embodiment, the pitch circle diameter PCDi of the inner-side rolling elements 3 is set larger than the pitch circle diameter PCDo of the outer-side rolling elements 3 (PCDi>PCDo). Each of the inner-side and outer-side rolling elements has the same size (diameter). However, due to the difference of the pitch circle diameters PCDi, PCDo, the number of the inner-side row of rolling elements 3 is set larger than the number of the outer-side row of rolling elements 3.

The pitch circle diameter PCDi of the inner-side rolling elements 3 is set larger than the pitch circle diameter PCDo of the outer-side rolling elements 3 (PCDi>PCDo). The number of the inner-side rolling elements 3 is set larger than the number of the outer-side rolling elements 3. This makes it possible to increase the bearing rigidity of the inner-side as compared with that of the outer-side. Thus, this extends the life of bearing and prevents the roundness of the inner raceway surface 20a from being lowered while suppressing deformation of the inner ring 20 that would be caused by the caulking process.

As a consequence of making the pitch circle diameter PCDi of the inner -side rolling elements 3 larger than the pitch circle diameter PCDo of the outer-side rolling elements 3, the thickness of the inner ring 20 is set large. Similarly to the first embodiment, the thickness h2 of the smaller end 20b of the inner ring 20 is set larger than the height H of the stepped portion 16 of wheel hub 19 (h2≦H). The distance L1 from the touch position P to the smatter end surface 20b is set small. A value is obtained by dividing a dimensionless value of the area A2 of the smaller end surface 20b of the inner ring 20 by a dimensionless value of the inner diameter d of the inner ring 5 and the value is set to 11 or more (A2/d≦11). In addition, the axial position of the smaller end surface 20b of the inner ring 20 is set within an axial range L2 between the axial position of the outermost-side point of the inner-side rolling elements 3 of the double row rolling elements 3 and 3 and the axial position of the groove bottom point of the inner raceway surface 20a of the inner ring 20.

This makes it possible to reduce the bearing friction by reducing the sensitivity of the elastic deformation of the inner ring 20 during the caulking process and by suppressing variation of the negative clearance after caulking. Also, it suppresses the hoop stress of the inner ring 22 caused by the caulking process.

In addition according to the present disclosure, a recessed portion 21 is formed on the inner-side end of the wheel hub 19. The depth of the recessed portion 21 extends to the axial position of the stepped portion 16 of the wheel hub 19. The cylindrical portion 19a has a circular cross-section. This makes it possible to reduce the hoop stress of the inner ring 20 while the weight of the wheel hub 19 is reduced. Expansion of the inner ring 20, by caulking, is suppressed, and the thickness of the inner ring 20 is increased.

FIG. 7 is a longitudinal-sectional view of a third embodiment of a wheel bearing apparatus of the present disclosure. This embodiment is different from the second embodiment (FIG. 6) basically in provision of a spacer between the inner ring and the caulking portion. Accordingly, the same reference numerals are used to designate the same structural elements of the previous embodiment and their detailed description will be omitted.

This wheel bearing apparatus of the third embodiment is also a so-called “third generation” type for a driven wheel. It includes an inner member 22, the outer member 18, and double row rolling elements (balls) 3, 3 rollably contained between the inner member 22 and the outer member 18. The inner member 22 includes a wheel hub 23 and the inner ring 20 press-fit onto the wheel hub 23, via a predetermined interference.

The wheel hub 23 is integrally formed with the wheel mounting flange 6 on its outer-side end. The wheel hub outer circumference includes one (outer-side) inner raceway surface 4a with a circular-arc longitudinal-section. A cylindrical portion 23a axially extends from the inner raceway surface 4a. The inner ring 20 is press-fit onto the cylindrical portion 23a of the wheel hub 23, via a predetermined interference. The inner ring 20 is axially immovably secured on the wheel hub 23 by the caulking portion 4c. The caulked portion 4c is formed by plastically deforming the end of the cylindrical portion 23a radially outward.

The wheel hub 23 is formed of medium-high carbon steel such as S53C including carbon of 0.40-0.80% by weight. It is hardened by high frequency induction hardening to have a surface hardness of 58-64 HRC over a region from the inner-side base 6b of the wheel mounting flange 6 to the cylindrical portion 23a including the outer-side inner raceway surface 4a.

According to this embodiment, the spacer 24, with a rectangular longitudinal section, is disposed on the cylindrical portion 23a of the wheel hub 23. The inner ring 20 is secured on the wheel hub 23 with the inner ring 20 and the spacer 24 sandwiched between the caulking portion 4c and the stepped portion 16 of the wheel hub 23. The spacer 24 is formed of a steel-based metallic material such as carbon steel S40C including carbon of 0.37-0.43% by weight. It is hardened by high frequency induction hardening to have a surface hardness of 40-50 HRC. This makes it possible to improve the durability of the inner ring 20 while reducing the deformation and therefore hoop stress of the inner ring 20 and to maintain the bearing preload at a proper value.

The present disclosure can be applied to the third generation wheel bearing apparatus of the caulking type where the inner ring is press-fit onto the cylindrical portion of the wheel hub and the inner ring is secured by caulking.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents thereof.

What is claimed is:

1. A wheel bearing apparatus comprising:
an outer member integrally formed on its outer circumference with a body mounting flange, the outer member inner circumference includes double row outer raceway surfaces;
an inner member includes a wheel hub and an inner ring, the wheel hub is integrally formed on its one end with a wheel mounting flange, the wheel hub outer circumference includes one inner raceway surface opposing one of the outer raceway surfaces, a cylindrical portion axially extends from the inner raceway surface through a stepped portion, the inner ring is formed, on its outer circumference, respectively, with the other inner raceway surface opposing the other of the double row outer raceway surfaces;
double row rolling elements are rollably contained between the inner raceway surfaces of the inner member and the outer raceway surfaces of the outer member;
the inner ring is axially immovably secured on the wheel hub by a caulking portion, the caulked portion is formed by plastically deforming, radially outward, an end of the cylindrical portion of the wheel hub;
thickness of a smaller end surface of the inner ring is larger than a height of the stepped portion of the wheel hub; and
axial position of the smaller end surface of the inner ring is set within an axial range between the axial position of the outermost-side point of the inner-side rolling elements of the double row rolling elements and an axial position of a groove bottom point of the inner raceway surface of the inner ring.

2. The wheel bearing apparatus of claim 1, wherein a value is obtained by dividing a dimensionless value of the area of the smaller end surface of the inner ring by a dimensionless value of the inner diameter of the inner ring and the value is set to 11 or more.

3. The wheel bearing apparatus of claim 1 wherein a recessed portion is formed on the inner-side end of the wheel hub, the depth of the recessed portion extends to the axial position of the stepped portion of the wheel hub, and the cylindrical portion has a circular cross-section.

4. The wheel bearing apparatus of claim 1, wherein a spacer, with a rectangular longitudinal section, is disposed on the cylindrical portion of the wheel hub so that the inner ring is secured on the wheel hub with the inner ring and the spacer being sandwiched between the caulking portion and the stepped portion of the wheel hub.

5. The wheel bearing apparatus of claim 1 wherein the pitch circle diameter (PCDi) of the inner-side rolling elements of the double row rolling elements is larger than the pitch circle diameter (PCDo) of the outer-side rolling elements of the double row rolling elements, the size of each double row rolling element is the same, and the number of the inner-side rolling elements is larger than that of the outer-side rolling elements.
